(19) United States
(12) Patent Application Publication
(10) Pub. No.: US 2005/0262311 A1
(43) Pub. Date: Nov. 24, 2005

(54) Hierarchical processor architecture for video processing

(76) Inventor: Louis A. Lippincott, Los Altos, CA (US)

Correspondence Address: INTEL CORPORATION, P.O. BOX 5326, SANTA CLARA, CA, 95056-5326, US

(21) Appl. No.: 10/850,095

(22) Filed: May 20, 2004

(51) Int. Cl. G06F 13/28

(52) U.S. Cl. 711/147

(57) ABSTRACT

A system may include a memory, a number of low-level processors, and a control processor. The memory may store indicator data, other data that is described by the indicator data, and instructions. The low-level processors may process the other data based on the instructions. The control processor may determine a subset of the instructions needed to process the other data from the indicator data. The control processor also may cause the subset of the instructions to be loaded into at least one of the number of low-level processors.

### BACKGROUND

Implementations of the claimed invention generally may relate to information processing and, more particularly, to processing received video information.

Certain types of processing tasks may involve both complex algorithms and a significant amount of data to be processed. Decoding, and/or encoding, of video information may be one such processing task. For example, different interlacing schemes, frame types, orderings, etc. of video information may present algorithmic complexity to a processor handling an incoming stream of video. A somewhat high frame rate and/or number of pixels per frame may also present a significant amount of data to be processed (e.g., computational load).

One way to handle such processing tasks may be to use a processor that can handle the logically complex tasks and still be fast/capable enough to handle significant amounts of data. Such an approach, however, may involve a relatively large, complex processor operating at a relatively fast clock frequency. Large, complex processors that operate at relatively fast clock frequencies may dissipate relatively high amounts of power.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 illustrates an example system;

FIG. 2 is a flow chart illustrating a process of operating on data;

FIG. 3 is an example video processing algorithm;

FIG. 4 illustrates how the system of FIG. 1 may implement the algorithm of FIG. 3; and

FIG. 5 illustrates how various programs in FIG. 4 may be stored in a memory.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the claimed invention. However, it will be apparent to those skilled in the art having the benefit of the present disclosure that the various aspects of the invention claimed may be practiced in other examples that depart from these specific details. In certain instances, descriptions of well known devices, circuits, and methods are omitted so as not to obscure the description of the present invention with unnecessary detail.

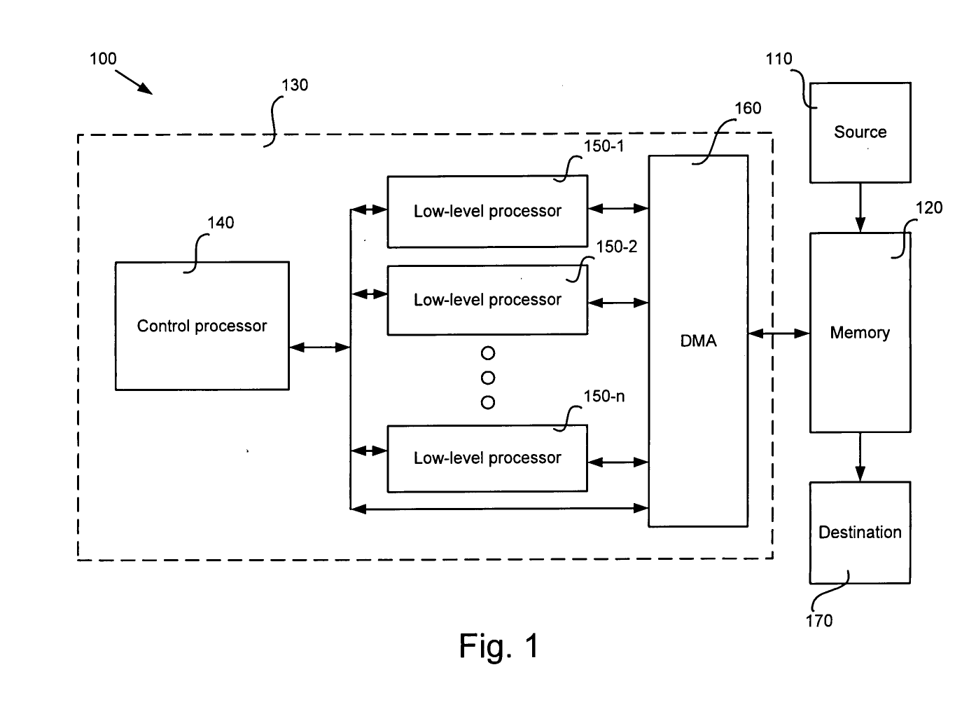

FIG. 1 illustrates an example system 100. Example implementations of system 100 may include personal video recorders (PVRs) or digital versatile disc recorders (DVD-Rs), although the claimed invention is not limited in this regard. For example, system 100 may be embodied within a general-purpose computer, a portable device, a consumer electronics device, or another electrical system. Although system 100 may be embodied in a single device, in some implementations certain components of system 100 may be remote and/or physically separated from other components of system 100. Further, although system 100 is illustrated as including discrete components, these components may be implemented in hardware, software/firmware, or some combination thereof. When implemented in hardware, some components of system 100 may be combined in a certain chip or device.

System 100 may include a data source 110, a memory 120, a data processor 130, and a data destination 170. Source 110 may send data to memory 120, and the data in memory 120 may be processed by data processor 130. The processed data may be sent to destination 170. For the purposes of explanation, the data sent and operated upon may include media data (e.g., video information), but the claimed invention is not limited in this regard. Data processor 130 may process other types of data than media information consistent with the description herein.

Source 110 may include a device that provides media information to the remainder of system 100. The media information provided by source 110 may include video information encoded in a format such as MPEG-1, MPEG-2, MPEG-4, H.264, Windows Media Video version 9 (WMV9) and Advanced Video System (AVS) formats. The claimed invention is not limited to the formats specifically mentioned herein; rather any now-known or later-developed media format may be used in accordance with the schemes disclosed herein.

In some implementations, source 110 may include a tuner to separate a stream or channel of video information (e.g., high definition (HD) MPEG-2 information) from other streams or channels of media information. In some implementations, source 110 may include a reader to read the media information from a storage medium. For example, such a reader may include an optical, magnetic, and/or electrical reader to extract the video information from a DVD, hard disk, semiconductor storage device, or other storage medium.

In some implementations, source 110 may include receiver circuitry to receive the media information from a communication link (not shown). Such receiver in source 110 may be arranged to receive information from a wired, optical, or wireless transmission medium. The receiver in source 110 may, or may not, operate in conjunction with a tuner or other device to separate desired information from other received information.

Memory 120 may receive media information from source 110 and store the media information. If instructed by data processor 130, memory 120 may provide processed media data to destination 170 and/or destination 170 may read such processed media data when triggered by data processor 130. Memory 120 may include random access memory (RAM) to facilitate rapid transfer and storage of data. Such RAM may be synchronous, asynchronous, double data rate (DDR), etc. according to the design parameters of system 100;

In addition to storing media data, memory 120 may store instructions for use by data processor 130 and/or its components. Such instructions may be task-specific, and may be provided to data processor 130 when requested. Memory 120 may include one or more sets of such instructions that, when loaded by data processor 130, enable data processor 130 to perform a variety of processing tasks on the data (e.g., media or video data) received from source 110.

Data processor 130 may include a control processor 140, a number of low-level processors 150-1, 150-2, . . . , 150-n (collectively “low-level processors 150”), and a direct memory access (DMA) 160. In some implementations, all of elements 130-160 may be located in the same chip or package. In some implementations, however, low level processors 160 and DMA 160 may be in one chip or package, while control processor 140 may be located in a separate chip or package. Other combinations and implementations are possible.

Control processor 140 may include sufficient instruction memory to control and/or coordinate a relatively complex processing operation. In handling such a complex operation (e.g., decoding video information), control processor may both determine what resources are needed for the task (e.g., by parsing an algorithm such as a decoding algorithm) and allocate resources to the task (e.g., by configuring low-level processors 150 appropriately). In this latter, allocation function, control processor 140 may be arranged to load task-specific instructions from memory 120 into low-level processors 150.

Some processing operations may be “data-driven” (e.g., defined by the data from source 110), and control processor 140 may examine indicator data to determine what type of processing should be performed. Control processor 140 may then configure low-level processors 150 with appropriate instructions from memory 120 to process the data from source 110 that follows the indicator data. Control processor 140 may also assign certain ones of low-level processors 150 to process certain data and/or perform certain tasks in parallel. Control processor 140 may reconfigure low-level processors 150, as needed, based on newly received indicator data. This control scheme will be described in greater detail below.

For processing tasks that involve logically complex tasks and relatively large amounts of data, control processor 140 may handle the logical complexity and may configure low-level processors 150 “on the fly,” if desired, to handle the amounts of data. To accomplish these functions, control processor 140 may have room in its instruction memory for more than about ten times the number of instructions (e.g., be at least ten times larger than) as low-level processors 150. In one implementation, control processor 140 may have about 32 kilobytes (KB) of instruction RAM, although the claimed invention is not limited in this regard.

Low-level processors 150 may include a number of processors with smaller amounts of instruction memory (e.g., less than a tenth as much) than control processor 140. In one implementation, low-level processors 150 each may have about 1.5 kilobytes (KB) of instruction RAM, although the claimed invention is not limited in this regard. Because of the smaller amounts of instruction memory, each of low-level processors 150 may perform a task corresponding to a relatively small code size. Low-level processors 150 also may lack, for example, one or more of caches, deep pipelines, branch prediction, speculative execution, etc. The relatively small memory and relatively simple structure of low-level processors 150, however, may result in power and size savings relative to more complex processors. In some implementations, low-level processors 150 may be homogeneous in structure and capability, and in some implementations, low-level processors 150 may be heterogeneous in structure and/or capability.

Although not explicitly illustrated in FIG. 1 for simplicity of explanation, low-level processors 150 may be interconnected in some implementations, for example, in a matrix-type arrangement where one of low-level processors 150 may be connected to one, two, three, or more others of low-level processors 150. In some implementations, there may be a single digit number of low-level processors 150 (e.g., four or eight), but in other implementations there may be a double-digit number of low-level processors 150 (e.g., 16, 20, 32, 40, etc.). Also, though low-level processors 150 will be described as executing a processing task, in some implementations each of low-level processors 150 may execute a sub-task in conjunction with one or more of low-level processors 150. Other architectural and processing flow variations are both possible and contemplated for low-level processors 150.

In any event, low-level processors 150 may receive instructions from memory 120 and data to process using those instructions in based on direction from control processor 140. Depending on the instructions received, each of low-level processors 150 may be arranged to be a specific-purpose processor, with different processing tasks possible among the processors. Low-level processors 150 may be arranged to retrieve and process their respective data, possibly in parallel. Further, any one of low-level processors 150 may be reconfigured (e.g., receive different instructions) as often as upon completion of its current task. Control processor 140 may, however, re-use (i.e., not reconfigure) some of low-level processors 150 if they are already configured for tasks that need to be performed. Because of configuration of low-level processors 150 by control processor 140, data processor 130 may be referred to as a hierarchical processor.

DMA 160 may read and/or write data from and/or to memory 120. In so doing, DMA 160 may facilitate control processor 140 reading indicator data from source 110. DMA 160 may also provide instruction data and data to be processed to low-level processors 150. DMA 160 also may control data flow among low-level processors 150. Although DMA 160 is illustrated as connected to memory 120 with a single connection, it should be understood that such merely shows bi-directional data transfer between DMA 160.and memory 120, and does not limit the claimed invention. In practice, one or more additional (e.g., control) connections may exist between DMA 160 and memory 120, even though not explicitly shown in FIG. 1. This illustrative principle also applies to other connections shown in FIG. 1.

Data destination 170 may be arranged to store or output processed data (e.g., decoded media or video information). In some implementations, destination 170 may include an output interface to provide another system or another component of system 100 (not shown) access to the data processed by data processor 130. Such a physical output interface may be optical, electrical, wireless, etc., and may conform to one or more existing or later-developed interface specifications for transmitting and/or accessing data.

In some implementations, destination 170 may include a storage device for storing the processed data. For example, destination 170 may include a hard disk or flash memory to store information. In some implementations, destination 170 may include a writeable optical drive (e.g., DVD-RW, etc.) to transfer processed information to a portable storage medium. A display processor (not shown) may access the stored information in destination 170 for playback or some other purpose at a later time.

Although several exemplary implementations have been discussed for destination 170, the claimed invention should not be limited to those explicitly mentioned, but instead should encompass any device or interface capable of transmitting or storing the processed information from memory 120. For example, destination 170 need not necessarily be separate or distinct from source 110 in some implementations. Decoded video information, in some implementations, may be re-inserted (e.g., by back modulation in another channel) into a stream from which it was received.

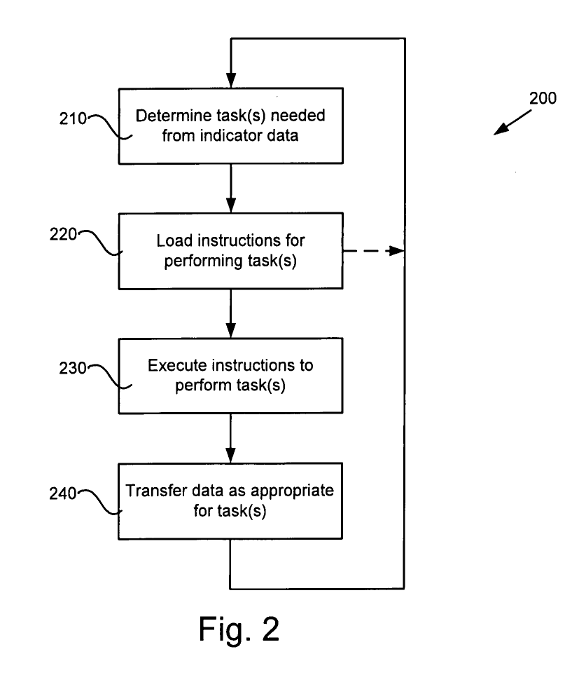

FIG. 2 is a flow chart illustrating a process 200 of operating on data. Although process 200 may be described with regard to system 100 for ease of explanation, the claimed invention is not limited in this regard. Processing may begin with control processor 140 reading indicator data from memory 120 and determining one or more tasks to be performed based on the indicator data [act 210]. Control processor 140 may make such determination using instructions (e.g., forming an algorithm) resident in its instruction memory. In one example, described in greater detail below, control processor 140 may execute a decoding algorithm for video data, and the indicator data used may be, for example, what type of encoding a particular frame of video data has.

Processing may continue with control processor 140 arranging for instructions for performing the one or more tasks to be loaded into one or more of low-level processors 150 [act 220]. In some implementations, control processor 140 may instruct DMA 160 to access appropriate instructions (e.g., micro-code program(s)) in memory 120 and pass them along to low-level processors 150. In some implementations, control processor 140 may instruct low-level processors 150 to obtain the instructions from memory 120 via DMA 160. As long as the indicator data precedes other data to be processed, control processor 140 may load instructions into low-level processors 150 with relatively low delay or latency.

Low-level processors 150 that have received instructions may execute the instructions to perform the one or more tasks determined by control processor 140 [act 230]. Such execution may begin shortly after loading the instructions, perhaps after minor configurations (e.g., where to retrieve data in memory 120) are made to low-level processors 150. As part of act 230, or an earlier act, control processor 140 or low-level processors 150 may program DMA 160 to deliver and accept data to and from low-level processors 150 during their processing tasks. Although a single low-level processor 150 may perform one computing task, in some implementations two or more low-level processors 150 may cooperate to perform one task. Also, low-level processors 150 may perform their respective task(s) or portions of such task(s) in parallel in some implementations.

Low-level processors 150 may transfer data to and from memory 120 via DMA 160 as appropriate for their respective processing task(s) [act 240]. When such processing is complete, the processed data may be transferred to memory 120 for buffering and/or transfer to destination 170.

Acts 210-240 may be repeated as appropriate for successive computing tasks. As described above, control processor 140 may perform and/or coordinate acts 210 and 220, and low-level processors 150 may perform and/or coordinate acts 230 and 240. Repetition of acts 210-240 may depend on when indicator data is received by memory 120. If, for example, the next piece of indicator data (e.g., indicating the next task or set of tasks) is not received until after low-level processors 150 have processed the data, control processor 140 may not repeat act 210 until after act 240, as illustrated by the solid arrow in FIG. 2.

If the next piece of indicator data is received before low-level processors 150 have processed the data, however, control processor 140 may repeat act 210 after act 220, as illustrated by the dashed arrow in FIG. 2. In such scenarios, if new indicator data is available, control processor 140 may finish loading instructions into some of low-level processors 150, and it may determine tasks and load instructions in acts 210 and 220 while the low-level processors 150 are executing in acts 230 and 240. Other processing flows between control processor 140 and low-level processors 150 are possible consistent with the description herein.

A specific example to aid in understanding system 100 and process 200 will now be presented. Although system 100 and process 200 may be amenable to decoding video information, as described below, the claimed invention should not be limited thereto. Further, system 100 and process 200 may be amenable to much more complicated algorithms, whether video decoding or other types, than are discussed below.

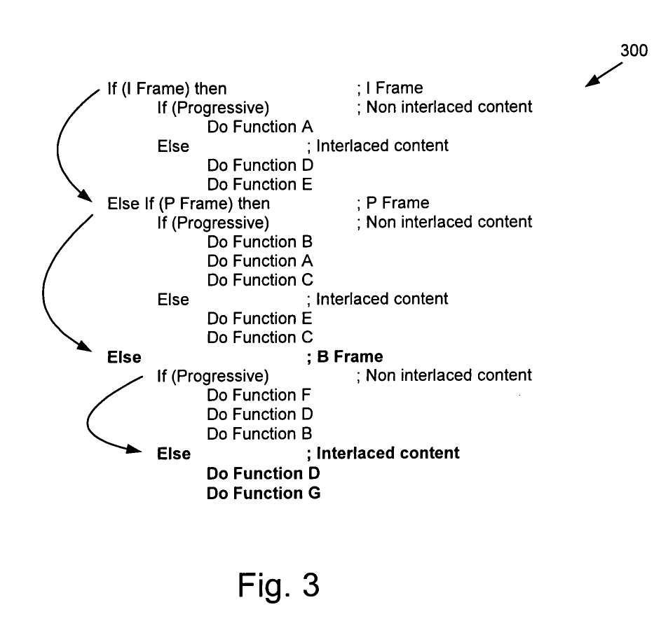

FIG. 3 illustrates an example video processing algorithm 300. Algorithm 300 may perform one or more of Functions A-G to decode a frame of video information, depending on whether the frame is an intracoded (I) picture, a predicted (P) picture, or a bi-directionally predicted (B) picture, and depending on whether the particular I, P, or B picture includes interlaced or progressively scanned video information. This type of frame (e.g., B frame) and mode of video (e.g., interlaced) information may be one example of indicator data, because it indicates what processing tasks should be performed on the remainder of the video data in the frame.

Assuming, for the sake of example, receipt of a B frame that is interlaced, algorithm 300 determines that Functions D and G be performed to decode such a frame of video information. The arrows in FIG. 3 illustrate the logical steps taken to make a determination of which functions to perform. Functions D and G may represent to distinct computational tasks necessary to decode an interlaced B frame of video data. Of course, there may be more or less tasks than two that are necessary to decode such a frame of video information, and the two shown are purely for the purposes of illustration and explanation.

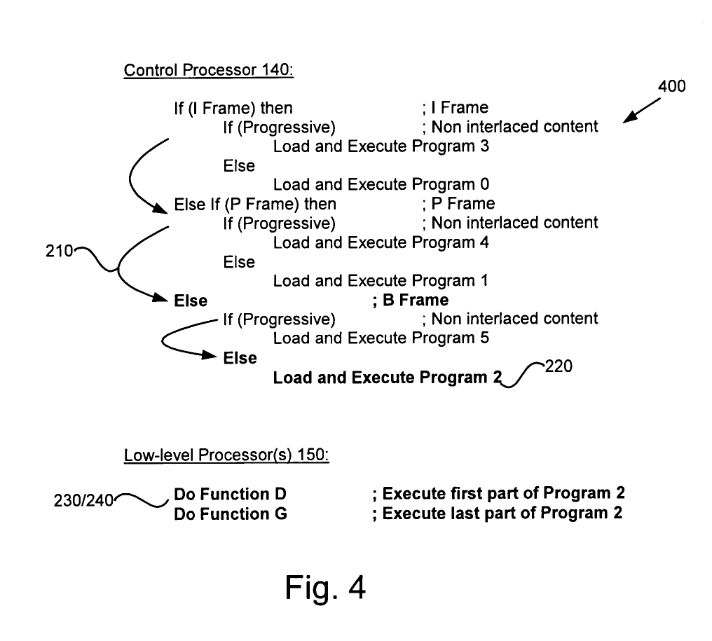

FIG. 4 illustrates how the system 100 may implement the algorithm 300, which is designated as algorithm 400 to indicate the different implementation. For comparison purposes, it will also be assumed that the video information to be processed is a B frame that is interlaced. As shown, control processor 140 may step through the logical portions of algorithm 400 [act 210] to determine what task(s) should be performed for an interlaced, B-type frame of data.

Control processor 140 may then load Program 2 [act 220] into one or more of low-level processors 150 and cause it to be executed. Based on the complexity of Program 2, control processor 140 may load corresponding instructions into a single one of low-level processors 150 or into multiple ones of low-level processors 150. Control processor 140 may determine whether to distribute Program 2 over multiple low-level processors 150, or such may be pre-determined and reflected in, for example, how Program 2 is stored in memory 120. Once control processor 140 has loaded Program 2, it may perform acts 21 and 220 again if the indicator data (e.g., frame type and/or mode) is available for another frame of video data.

Low-level processor(s) 150 may then perform Functions D and G, the first and second parts of program 2 [acts 230/240]. In some implementations, one low-level processor (e.g., 150-1) may perform both of Functions D and G. In some implementations, one low-level processor (e.g., 150-1) may perform Function D, and one low-level processor (e.g., 150-2) may perform Function G. In some implementations, two or more low-level processors 150 may cooperate to perform at least one of Functions D and G, such as Function G. Other implementations are possible consistent with the description herein.

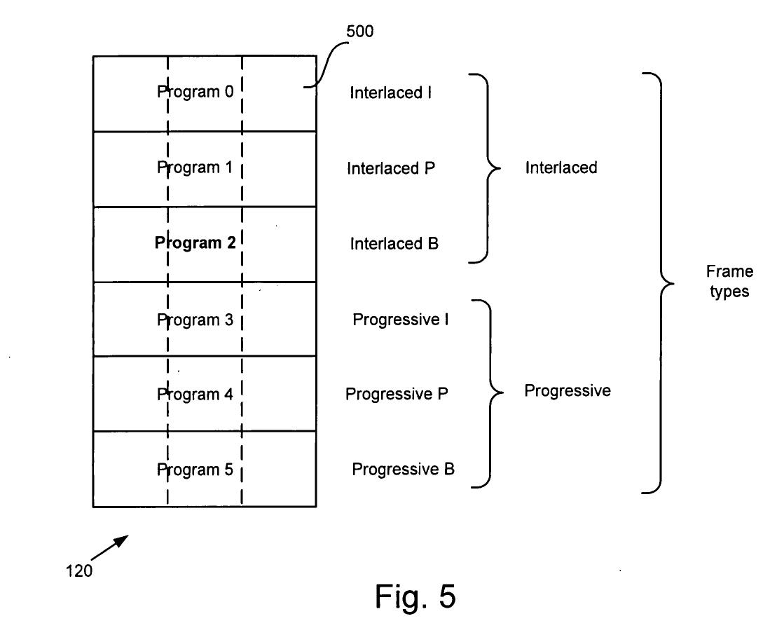

FIG. 5 illustrates how Programs 0-5 may be stored in memory 120. Structure 500 may include a data structure such as a linked list, an array, etc. within memory 120. Programs 0-5 may reside at certain addresses in structure 500, notionally illustrated by rows within the structure. In some implementations, the same version of a program (e.g., Program 2) is executed by any of low-level processors 150.

The dotted lines defining columns within structure 500 denote the possibility of different treatment of a program (e.g., Program 2) for different ones of low-level processors 150. In some implementations, for example, a program (e.g., Program 2) may be split into a number of portions (e.g., three in FIG. 5, although this should not limit the claimed invention) for different low-level processors (e.g., 150-1 to 150-3) to execute. For example, a first part of Program 2 may be instructions to perform Function D, and a second (and possible third) portion of Program 2 may be instructions to perform Function G. In some implementations, different ones of low-level processors 150 may load subtly different versions of a program (e.g., Program 2 or a portion thereof) to aid in addressing, data transfer, etc.

The division of highly-complex tasks from computationally-intensive tasks described herein permits system 100 to include a possibly lower-performance (e.g., lower power) control processor 140 that can handle the logical complexity of an algorithm and many lower-complexity (e.g., smaller and/or lower power) low-level processors 150 to handle the computational load of the algorithm. Using such a scheme, system 100 may consume less power than would be otherwise possible for the same computational operation (e.g., video decoding). Both high performance and low power usage may be obtained by system 100, because in video decompression, for example, the indicator data (e.g., detailed information about what processing tasks will be upcoming) is transmitted ahead of the other data. Using such indicator data, control processor 140 may customize and/or reconfigure the remainder of data processor 130 on the fly to perform just that upcoming task.

The foregoing description of one or more implementations consistent with the principles of the invention provides illustration and description, but is not intended to be exhaustive or to limit the scope of the invention to the precise form disclosed. Modifications and variations are possible in light of the above teachings or may be acquired from practice of various implementations of the invention.

For example, the hierarchical processing scheme described herein is not limited to video data. Rather, it may be applied to any data for which indicator data (e.g., data which indicates a future processing task) is available with which to configure low-level processors 150, or another processor or logic that is programmable on the fly. Also, although shown as a unitary device, in some implementations memory 120 may include multiple devices. For example, the data to be processed may be stored in a relatively large RAM, while the instructions for low-level processors 150 may be stored in a smaller RAM, a dedicated read-only memory (ROM), or some other separate storage device.

Further, although control processor 140 handled the algorithmic complexity and low-level processors 150 handled the data processing, such rigid separation of complexity and processing need not always occur. For example, control processor 140 may, in some instances, process data, and low-level processors 150 may, in some instances, handle limited logical parsing and/or decision making. In such hybrid schemes, however, it mat still be desirable for low-level processors 150 to process as much data as practical and for control processor 140 to handle as much of the algorithmic complexity as practical. Also, although decoding of video information has been described as one implementation, other functions are possible in other implementations. For example, system 100 may be arranged to encode media information, to render media information, to model physical phenomena, or to perform other, relatively complex numerical operations that may involve processing a large amount of data.

Moreover, the acts in FIG. 2 need not be implemented in the order shown; nor do all of the acts necessarily need to be performed. Also, those acts that are not dependent on other acts may be performed in parallel with the other acts. Further, at least some of the acts in this figure may be implemented as instructions, or groups of instructions, implemented in a machine-readable medium.

No element, act, or instruction used in the description of the present application should be construed as critical or essential to the invention unless explicitly described as such. Also, as used herein, the article “a” is intended to include one or more items. Where only one item is intended, the term “one” or similar language is used. Variations and modifications may be made to the above-described implementation(s) of the claimed invention without departing substantially from the spirit and principles of the invention. All such modifications and variations are intended to be included herein within the scope of this disclosure and protected by the following claims.

1. A system, comprising:
a memory to store indicator data, other data that is described by the indicator data, and instructions;
a plurality of low-level processors to process the other data based on the instructions;
a control processor to determine a subset of the instructions needed to process the other data from the indicator data and to cause the subset of the instructions to be loaded into at least one of the plurality of low-level processors.

2. The system of claim 1, wherein the control processor is operatively connected to each of the plurality of low-level processors.

3. The system of claim 1, wherein each low-level processor includes an instruction memory of a first size, and
wherein the control processor includes an instruction memory of a second size that is at least ten times the first size.

4. The system of claim 1, further comprising:
a direct memory access device connected to the memory, the plurality of low-level processors, and the control processor to coordinate transfer of the indicator data, the other data, and the instructions.

5. The system of claim 4, wherein the direct memory access device and the plurality of low-level processors are included in a common chip.

6. The system of claim 5, wherein the control processor is included in the common chip.

7. The system of claim 1, further comprising:
a data source to provide the indicator data and the other data to the memory.

8. The system of claim 7, wherein the data source includes:
a tuner or communication circuitry.

9. The system of claim 1, further comprising:
a data destination to receive data that has been processed by the plurality of low-level processors.

10. The system of claim 9, wherein the data destination includes:
a storage device or an output interface.

11. A method, comprising:
determining from first data, by a first processor, a task to be performed;
loading instructions to perform the task into a second processor; and
executing the instructions to perform the task on second data.

12. The method of claim 11, further comprising:
transferring the second data to the second processor during the task.

13. The method of claim 11, wherein the first data describes the second data.

14. The method of claim 13, wherein the second data includes video information, and
wherein the first data includes at least a type of encoding of the video information.

15. The method of claim 13, wherein the second data includes video information, and
wherein the first data includes at least a display mode of the video information.

16. The method of claim 11, further comprising:
determining from third data, by the first processor and after said loading, another task to be performed; and
loading other instructions to perform the another task into a third processor.

17. The method of claim 16, further comprising:
executing the other instructions to perform the another task on fourth data that is described by the third data.

18. An apparatus, comprising:
first processors to process first data based on programs provided thereto;
a second processor to determine appropriate programs to provide to the first processors based on second data that describes the first data; and
a memory accessor connected to the first processors and the second processors to provide the first data and the appropriate programs to the first processors and to provide the second data to the second processor.

19. The apparatus of claim 18, wherein the first processors and the memory accessor are included in a package.

20. The apparatus of claim 18, wherein the first processors include at least eight distinct processors.

21. The apparatus of claim 18, wherein a first processor includes a first instruction memory, and
wherein the second processor includes a second instruction memory at least ten times larger than the first instruction memory.

22. A machine-accessible medium including instructions that, when executed, cause a machine to:
determine one computing task of a number of computing tasks to perform on first data based on second data that characterizes the first data;
load other instructions that perform the one computing task; and
execute the other instructions to perform the one computing task on the first data.

23. The machine-accessible medium of claim 22, further including instructions that, when executed, cause a machine to:
distribute the other instructions that perform the one computing task among a plurality of distinct processors in the machine.
